(19) United States
(12) Patent Application Publication
(10) Pub. No.: US 2026/0051654 A1
(43) Pub. Date: Feb. 19, 2026

(54) Antenna System, Antenna Isolation Adjustment Method, and Air Interface Cancellation Structure

(71) Applicant: HUAWEI TECHNOLOGIES CO., LTD., Shenzhen (CN)

(72) Inventors: Tao Pu, Shanghai (CN); Qiang Wang, Shanghai (CN); Shenjie Xia, Shanghai (CN); Yuan Liu, Chengdu (CN); Luyu Zhao, Xi'an (CN)

(73) Assignee: HUAWEI TECHNOLOGIES CO., LTD., Shenzhen (CN)

(21) Appl. No.: 19/368,122

(22) Filed: Oct. 24, 2025

Related U.S. Application Data
(63) Continuation of application No. PCT/CN2024/075466, filed on Feb. 2, 2024.

(30) Foreign Application Priority Data
Apr. 25, 2023 (CN) 202310470880.8

(51) Int. Cl. H01Q 1/52; H01Q 3/28; H01Q 3/36; H01Q 21/30

(52) U.S. Cl. CPC H01Q 1/521; H01Q 3/28; H01Q 3/36; H01Q 21/30

(57) ABSTRACT

An antenna system, an antenna isolation adjustment method, and an air interface cancellation structure may be applied to a full-duplex communication system to implement air interface cancellation of an environment interference path. The system includes a first antenna array, a second antenna array, N air interface cancellation structures, and a feedback circuit. The N air interface cancellation structures perform phase adjustment or both phase adjustment and amplitude adjustment on a communication signal between the first antenna array and the second antenna array based on signal information of the communication signal and signal information of a received hybrid signal that are obtained by the feedback circuit, to adjust isolation between a first radio frequency port set of the first antenna array and a second radio frequency port set of the second antenna array.

### CROSS-REFERENCE TO RELATED APPLICATIONS

This is a continuation of International Patent Application No. PCT/CN2024/075466 filed on Feb. 2, 2024, which claims priority to Chinese Patent Application No. 202310470880.8 filed on Apr. 25, 2023, both of which are incorporated by reference.

### TECHNICAL FIELD

This disclosure relates to the field of wireless communication, and more specifically, to an antenna system, an antenna isolation adjustment method, and an air interface cancellation structure.

### BACKGROUND

With rapid development of wireless communication technologies, wireless communication services have increasing requirements for spectrum resources. Compared with time-division duplexing (TDD) and frequency-division duplexing (FDD), a full-duplex technology can enable a wireless communication device to transmit and receive a wireless signal at a same time at a same frequency, and therefore is widely concerned and studied. Transmit-receive isolating is an important indicator for measuring performance of a full-duplex system, and is mainly related to antenna isolation and designing of receive and transmit channels in a radio frequency module. Therefore, how to implement a high-isolation antenna becomes a key to improving the performance of the full-duplex system.

Currently, a method for improving antenna isolation includes a solution for increasing the antenna isolation based on radio frequency cancellation and a solution for increasing the antenna isolation based on a passive structure. The former increases circuit complexity and costs, and the latter can only improve the antenna isolation, but cannot cancel an interference signal from an environment.

### SUMMARY

This disclosure provides an antenna system, an antenna isolation adjustment method, and an air interface cancellation structure, to eliminate an environment interference path by using an air interface technology, so as to ensure high isolation between radio frequency ports of an antenna.

According to a first aspect, an embodiment of this disclosure provides an antenna system. The system includes a first antenna array, a second antenna array, N air interface cancellation structures, and a feedback circuit, where the first antenna array includes a first radio frequency port set, the second antenna array includes a second radio frequency port set, the N air interface cancellation structures are located between the first antenna array and the second antenna array, the N air interface cancellation structures are sequentially arranged from the first antenna array to the second antenna array, the feedback circuit is connected to the first antenna array, the second antenna array, and the N air interface cancellation structures, and N is an integer greater than or equal to 1. The first antenna array is configured to transmit a communication signal; the N air interface cancellation structures are configured to perform phase adjustment or both phase adjustment and amplitude adjustment on a part of the communication signal to generate an adjusted signal; the second antenna array is configured to receive a hybrid signal, where the hybrid signal includes the adjusted signal and an interference signal, and the interference signal is a signal generated based on another part of the communication signal; and the feedback circuit is configured to: obtain signal information of the communication signal and signal information of the hybrid signal, and adjust isolation between the first radio frequency port set and the second radio frequency port set based on the signal information of the communication signal and the signal information of the hybrid signal.

In the solution of this disclosure, the signal information is information related to a signal, for example, a phase, an amplitude, and a frequency of the signal.

It should be understood that, because both the first antenna array and the second antenna array belong to one base station, when the first antenna array sends the communication signal to another communication device (for example, a client device), not all of the communication signal sent by the first antenna array is received by the client device. A part of the signal is received by the second antenna array; or reaches the second antenna array again due to an environment interference path, device reflection, or the like, and interferes with the second antenna array in receiving a communication signal from another communication device (for example, a client device). Therefore, a coupled signal and an interference signal between the first antenna array and the second antenna array may need to be eliminated, that is, a hybrid signal passively received by the second antenna array may need to be sufficiently low in power, so that receiving of the communication signal from the other communication device by the second antenna array is not affected. In the solution of this disclosure, the air interface cancellation structure is disposed between the first antenna array and the second antenna array, to perform phase adjustment or both phase adjustment and amplitude adjustment on a coupled signal that directly reaches the second antenna array, to generate the adjusted signal; and perform phase superposition and cancellation control, thereby implementing a function of an amplitude adjustment unit, and potentially achieving a larger cancellation amplitude range. In addition, in the solution provided in this disclosure, the received hybrid signal is compared with the transmitted communication signal via the feedback circuit, to adjust the isolation between the first radio frequency port set and the second radio frequency port set. In the air interface cancellation solution provided in this disclosure, no hardware circuit may need to be added to a coupling path of a radio frequency port, thereby avoiding an increase in circuit complexity caused by hardware addition. In addition, isolation between radio frequency ports can be adjusted in time by obtaining the real-time signal information of the transmitted communication signal and the received hybrid signal, to flexibly adjust the isolation between the radio frequency ports based on a dynamic environment.

With reference to the first aspect, in some implementations of the first aspect, the feedback circuit includes a first input end and a second input end. The first input end is configured to obtain the signal information of the communication signal via a first power device and a first circuit switching element. The second input end is configured to obtain the signal information of the hybrid signal via a second circuit switching element.

In some embodiments, the first circuit switching element and the second circuit switching element may be single-pole double-throw switches, triodes, or the like. This is not limited in this disclosure.

In some embodiments, the first power device may be a power divider, a coupler, or the like. This is not limited in this disclosure.

Based on the foregoing solution, a coupling channel is added between a transmit channel and a receive channel of each of the first antenna array and the second antenna array, so that power of the transmit channel can be monitored in real time by introducing a coupling circuit. Each of the coupling channel and the receive channel further includes a multiplexer switch, so that dynamic switching can be implemented based on a service requirement or isolation monitoring.

With reference to the first aspect, in some implementations of the first aspect, each of the N air interface cancellation structures includes one layer or a plurality of layers.

With reference to the first aspect, in some implementations of the first aspect, each air interface cancellation structure includes the plurality of layers, the plurality of layers include a phase adjustment layer or both an amplitude adjustment layer and a phase adjustment layer, the amplitude adjustment layer is configured to adjust an amplitude of the communication signal, and the phase adjustment layer is configured to adjust a phase of a signal obtained after amplitude adjustment.

Based on the foregoing solution, the air interface cancellation structure is set to the plurality of layers, so that one air interface cancellation structure can adjust both a phase and an amplitude of the communication signal, thereby improving an adjustment capability of a system, and further improving isolation under environment impact.

With reference to the first aspect, in some implementations of the first aspect, each air interface cancellation structure includes a plurality of resonance elements, and the plurality of resonance elements include at least one resonance element for phase adjustment.

With reference to the first aspect, in some implementations of the first aspect, each layer of each air interface cancellation structure includes a plurality of resonance elements, each of the plurality of resonance elements includes a positive electrode and a negative electrode, and each of the plurality of resonance elements further includes at least one switch or at least one varactor diode.

With reference to the first aspect, in some implementations of the first aspect, at least one layer of each air interface cancellation structure includes k switches or k varactor diodes, and k satisfies k>max(j,m), where j is a quantity of first radio frequency ports in the first radio frequency port set, m is a quantity of second radio frequency ports in the second radio frequency port set, and both j and m are integers greater than or equal to 1.

With reference to the first aspect, in some implementations of the first aspect, the plurality of resonance elements are periodically arranged resonance elements, and include resonance elements in p rows and q columns, where p is an integer greater than or equal to 1, and q is an integer greater than or equal to 1.

Based on the foregoing solution, the plurality of resonance elements in the air interface cancellation structure are periodically arranged, so that space utilization of the air interface cancellation structure can be effectively increased.

With reference to the first aspect, in some implementations of the first aspect, a long side of each resonance element is less than 0.5 time a wavelength of the communication signal.

With reference to the first aspect, in some implementations of the first aspect, the long side of each resonance element is 0.2 time to 0.3 time the wavelength of the communication signal.

With reference to the first aspect, in some implementations of the first aspect, a cross section of each of the N air interface cancellation structures is of a right-angle L-shaped structure or an arc L-shaped structure.

Based on the foregoing solution, the air interface cancellation structure is bent, so that when a line length of a cross section of the air interface cancellation structure remains unchanged, a profile/thickness of an antenna can be greatly reduced in a case in which an isolation adjustment capability does not change greatly.

With reference to the first aspect, in some implementations of the first aspect, a line length of the cross section of each of the N air interface cancellation structures is 0.2 time to 0.6 time the wavelength of the communication signal.

With reference to the first aspect, in some implementations of the first aspect, a width of each of the N air interface cancellation structures is greater than or equal to a larger value of a width of the first antenna array and a width of the second antenna array.

With reference to the first aspect, in some implementations of the first aspect, a spacing between the first antenna array and the second antenna array is 1 time the wavelength of the communication signal.

With reference to the first aspect, in some implementations of the first aspect, the spacing between the first antenna array and the second antenna array is 1 time to 1.5 times the wavelength of the communication signal.

With reference to the first aspect, in some implementations of the first aspect, a spacing between a 1^{st} air interface cancellation structure in the N air interface cancellation structures and an edge of the first antenna array is 0.25 time the wavelength of the communication signal.

With reference to the first aspect, in some implementations of the first aspect, a spacing between an N^{th} air interface cancellation structure in the N air interface cancellation structures and an edge of the second antenna array is 0.25 time the wavelength of the communication signal.

In this embodiment of this disclosure, the spacing between the 1^{st} air interface cancellation structure and the edge of the first antenna array is approximately 0.25 time the wavelength of the communication signal. For example, the spacing between the 1^{st} air interface cancellation structure and the edge of the first antenna array may fluctuate within a range of 0.25±20% time the wavelength. Similarly, a distance between the second antenna array and the Nth air interface cancellation structure may still fluctuate within a range, for example, 0.25±20% time the wavelength of the communication signal.

It should be noted that when the distance between the air interface cancellation structure and the antenna array is approximately 0.25 time the wavelength of the communication signal, a radiation direction of the antenna element in the antenna array is not affected, and the communication signal can be fully coupled, that is, sufficient coupled electromagnetic waves from the first antenna array to the second antenna array can be intercepted. This improves system reliability.

With reference to the first aspect, in some implementations of the first aspect, the feedback circuit is further configured to: generate initial isolation between the first radio frequency port set and the second radio frequency port set based on the signal information of the communication signal and the signal information of the hybrid signal, generate bias voltages of a plurality of resonance elements in each of the N air interface cancellation structures based on the initial isolation, and change a transmission coefficient or a reflection coefficient of each of the N air interface cancellation structures by adjusting the bias voltages of the plurality of resonance elements, to adjust the isolation between the first radio frequency port set and the second radio frequency port set.

Based on the foregoing solution, in this disclosure, the isolation is recorded in real time, and the bias voltage of each of the plurality of resonance elements is calculated based on the isolation, to adjust the air interface cancellation structure. In this solution, the resonance elements can be separately controlled. Therefore, flexibility of isolation adjustment can be further improved. The antenna system provided in this disclosure applicable to environments with different degrees of interference, to meet different application scenarios.

With reference to the first aspect, in some implementations of the first aspect, the first antenna array is a dual-polarized antenna array.

With reference to the first aspect, in some implementations of the first aspect, the second antenna array is a dual-polarized antenna array.

According to a second aspect, an embodiment of this disclosure provides an antenna isolation adjustment method. The method is applied to an antenna system. The antenna system includes a first antenna array, a second antenna array, N air interface cancellation structures, and a feedback circuit, where the first antenna array includes a first radio frequency port set, the second antenna array includes a second radio frequency port set, the N air interface cancellation structures are located between the first antenna array and the second antenna array, the N air interface cancellation structures are sequentially arranged from the first antenna array to the second antenna array, the feedback circuit is connected to the first antenna array, the second antenna array, and the N air interface cancellation structures, and N is an integer greater than or equal to 1. The method includes: obtaining signal information of a communication signal transmitted by the first antenna array; obtaining signal information of a hybrid signal received by the second antenna array, where the hybrid signal includes an adjusted signal and an interference signal, the adjusted signal is generated by performing phase adjustment or both phase adjustment and amplitude adjustment on a part of the communication signal by the N air interface cancellation structures, and the interference signal is generated based on another part of the communication signal; and adjusting isolation between the first radio frequency port set and the second radio frequency port set based on the signal information of the communication signal and the signal information of the hybrid signal.

With reference to the second aspect, in some implementations of the second aspect, the feedback circuit includes a first input end and a second input end. The method further includes: obtaining, via a first power device and a first circuit switching element, a communication signal sent by a first radio frequency port connected to the first input end, where the communication signal sent by the first radio frequency port connected to the first input end is a part of the communication signal, and obtaining the signal information of the communication signal transmitted by the first antenna array includes: obtaining signal information of the communication signal sent by the first radio frequency port connected to the first input end; and obtaining, via a second circuit switching element, a hybrid signal received by a second radio frequency port connected to the second input end, where the hybrid signal received by the second radio frequency port connected to the second input end is a part of the hybrid signal, and obtaining the signal information of the hybrid signal received by the second antenna array includes: obtaining signal information of the hybrid signal received by the second radio frequency port connected to the second input end.

With reference to the second aspect, in some implementations of the second aspect, adjusting the isolation between the first radio frequency port set and the second radio frequency port set based on the signal information of the communication signal and the signal information of the hybrid signal includes: generating initial isolation between the first radio frequency port set and the second radio frequency port set based on the signal information of the communication signal and the signal information of the hybrid signal, generating bias voltages of a plurality of resonance elements in each of the N air interface cancellation structures based on the initial isolation, and changing a transmission coefficient or a reflection coefficient of each of the N air interface cancellation structures by adjusting the bias voltages of the plurality of resonance elements, to adjust the isolation between the first radio frequency port set and the second radio frequency port set.

According to a third aspect, an embodiment of this disclosure provides an air interface cancellation structure. The air interface cancellation structure is arranged between a first antenna array and a second antenna array. The air interface cancellation structure includes: The air interface cancellation structure is configured to perform phase adjustment or both phase adjustment and amplitude adjustment on a part of a communication signal to generate an adjusted signal, where each air interface cancellation structure includes a plurality of resonance elements, the plurality of resonance elements include at least one resonance element for phase adjustment, each of the plurality of resonance elements includes a positive electrode and a negative electrode, and each of the plurality of resonance elements further includes at least one switch or at least one varactor diode.

With reference to the third aspect, in some implementations of the third aspect, the air interface cancellation structure includes one layer or a plurality of layers.

With reference to the third aspect, in some implementations of the third aspect, each air interface cancellation structure includes the plurality of layers, the plurality of layers include a phase adjustment layer or both an amplitude adjustment layer and a phase adjustment layer, the amplitude adjustment layer is configured to adjust an amplitude of the communication signal, and the phase adjustment layer is configured to adjust a phase of a signal obtained after amplitude adjustment.

With reference to the third aspect, in some implementations of the third aspect, a transmission coefficient or a reflection coefficient of the air interface cancellation structure is associated with a bias voltage of each resonance element.

With reference to the third aspect, in some implementations of the third aspect, at least one layer of the air interface cancellation structure includes k switches or k varactor diodes, and k satisfies k>max(j,m), where j is a quantity of first radio frequency ports in a first radio frequency port set included in the first antenna array, m is a quantity of second radio frequency ports in a second radio frequency port set included in the second antenna array, and both j and m are integers greater than or equal to 1.

With reference to the third aspect, in some implementations of the third aspect, a long side of each resonance element is less than 0.5 time a wavelength of the communication signal.

With reference to the third aspect, in some implementations of the third aspect, the long side of each resonance element is 0.2 time the wavelength of the communication signal.

With reference to the third aspect, in some implementations of the third aspect, a cross section of each air interface cancellation structure is of a right-angle L-shaped structure or an arc L-shaped structure.

With reference to the third aspect, in some implementations of the third aspect, a line length of the cross section of each of N air interface cancellation structures is 0.2 time to 0.6 time the wavelength of the communication signal.

For a beneficial effect brought by the second aspect or the third aspect, refer to the descriptions of the beneficial effect in the first aspect. Details are not described herein again.

### BRIEF DESCRIPTION OF DRAWINGS

FIG. 1 is a diagram of a system architecture of an integrated access and backhaul (IAB) system to which an embodiment of this disclosure is applicable.

FIG. 2 is a diagram of an architecture for improving antenna isolation based on a radio frequency circuit.

FIG. 3 is a diagram of an architecture for improving isolation between co-frequency transmit and receive antennas.

FIG. 4 is a diagram of an architecture of an antenna system according to an embodiment of this disclosure.

FIG. 5 is a diagram of a structure of a first antenna according to an embodiment of this disclosure.

FIG. 6 is a diagram of an antenna port division manner according to an embodiment of this disclosure.

FIG. 7 is a diagram of an air interface cancellation structure whose cross section is of a right-angle L-shaped structure according to an embodiment of this disclosure.

FIG. 8 is a diagram of an air interface cancellation structure whose cross section is of an arc L-shaped structure according to an embodiment of this disclosure.

FIG. 9 is a diagram of an air interface cancellation structure of a multi-layer coupling structure according to an embodiment of this disclosure.

FIG. 10 is a diagram of structures of four possible resonance elements according to an embodiment of this disclosure.

FIG. 11 is a diagram of four possible amplitude adjustment principles.

FIGS. 12A and 12B are diagrams of cancellation capabilities of a phase resonance element and an amplitude resonance element for an interference path according to an embodiment of this disclosure.

FIG. 13 is a diagram of a structure of a multi-layer resonance element according to an embodiment of this disclosure.

FIG. 14 shows change curves of a transmission coefficient of an air interface cancellation structure in a case in which a varactor diode is at different capacitances.

FIG. 15 is a schematic flowchart of an isolation adjustment method according to an embodiment of this disclosure.

FIG. 16 is a diagram of a structure of a feedback circuit according to an embodiment of this disclosure.

FIG. 17 is a diagram of a structure of an adjustment module according to an embodiment of this disclosure.

FIG. 18 is a diagram of an architecture of an antenna system into which no interference path is introduced according to an embodiment of this disclosure.

FIG. 19 is a top view of a first antenna array and a second antenna array in an antenna system 1800 according to an embodiment of this disclosure.

FIG. 20 is a diagram of a structure of an air interface cancellation structure and a diagram of a location of the air interface cancellation structure used in an antenna system according to an embodiment of this disclosure.

FIGS. 21A-21D show curves of comparison between S parameters of antenna arrays of air interface cancellation structures corresponding to five different types of coupling ports into which no interference path is introduced and S parameters of antenna arrays into which no air interface cancellation structure is introduced.

FIG. 22 is a diagram of an architecture of an antenna system into which an interference path is introduced according to an embodiment of this disclosure.

FIGS. 23A-23D show curves of comparison between S parameters of antenna arrays of air interface cancellation structures corresponding to five different types of coupling ports into which an interference path is introduced and S parameters of antenna arrays into which no air interface cancellation structure is introduced.

FIG. 24 is a diagram of an architecture of an antenna system into which a dielectric column is introduced according to an embodiment of this disclosure.

FIGS. 25A-25D are diagrams of a comparison between various coupling amplitudes in an antenna array before a dielectric column is introduced and various coupling amplitudes in the antenna array after the dielectric column is introduced according to an embodiment of this disclosure.

### DETAILED DESCRIPTION

The following describes technical solutions of this disclosure with reference to accompanying drawings.

It should be noted that, in descriptions of embodiments of this disclosure, “a plurality of” means two or more than two, and “at least one” and “one or more” mean one, two, or more than two. The singular expression forms “one”, “a”, “the”, “the foregoing”, “this”, and “the one” are also intended to include expression forms such as “one or more”, unless otherwise specified in the context clearly.

The terms “first” and “second” mentioned below are merely intended for a purpose of description, and shall not be understood as an indication or implication of relative importance or an implicit indication of a quantity of indicated technical features. Therefore, a feature limited by “first”or “second”may explicitly or implicitly include one or more features.

In the following embodiments of this disclosure, the terms such as “include”, “have”, and any variants thereof are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

In embodiments of this disclosure, the terms such as “example” or “for example” indicate giving an example, an illustration, or a description. Any embodiment or design scheme described with “example” or “for example” should not be explained as being more preferred or having more advantages than another embodiment or design scheme. Use of the term such as “example” or “for example” is intended to present a related concept in a specific manner for ease of understanding.

In embodiments of this disclosure, a same reference numeral indicates a same component or a same part. In addition, parts in the accompanying drawings are not drawn based on an actual scale. Dimensions and sizes of the parts shown in the figures are merely examples, and should not be understood as a limitation on this disclosure.

An interference path mentioned in embodiments of this disclosure may come from the following scenarios: 1. pole impact, 2. hoop impact, 3. an ice-coated cable cover, 4. a surrounding cable (coaxial cable and wire) 5. a monitoring horizontal bar; 6. blocking of a surrounding tree; and 7. a fence, a building, a wire mesh, and the like.

The technical solutions in this disclosure may be further applied to various communication systems, for example, a Long-Term Evolution (LTE) system, an LTE FDD system, an LTE TDD system, a Universal Mobile Telecommunications System (UMTS), a Worldwide Interoperability for Microwave Access (WiMAX) communication system, a 5th generation (5G) system, a new radio (NR) system, a wireless-fidelity (Wi-Fi) system, a 3rd Generation Partnership Project (3GPP)-related communication system, and another communication system (such as a 6G system) or a plurality of communication convergence system that may appear in the future.

The technical solutions in this disclosure may be applied to a full-duplex system. Full-duplex communication is also referred to as bidirectional simultaneous communication, that is, an information exchange manner in which two communication parties can simultaneously send and receive information. The full-duplex system can theoretically improve spectral efficiency by 100%, and therefore becomes an important direction of a future communication technology, to improve network performance and customer experience. The technical solutions in this disclosure may be further applied to a multiple-input multiple-output system, for example, an IAB communication system. An intermediate IAB node includes a mobile terminal (MT) and a distributed unit (DU). The MT serves as a wireless transmission backhaul link, and is connected to a donor base station. The DU is an access-side cell under the IAB node, and provides access for common user equipment (UE). The IAB node is deployed in an integrated manner. Compared with a wired transmission mode, in integrated installation, no embedded optical fiber may be required. This reduces a deployment requirement for a wired transmission network. The IAB node can be deployed in outdoor and indoor scenarios in which wired transmission networks are difficult to deploy, and operates in an in-band full-duplex mode. In an IAB node in a same frequency band, when a DU sends a signal to UE, an MT can receive a signal from a donor base station, and when the MT sends a signal to the donor base station, the DU can receive a signal from the UE. In other words, a downlink of the donor base station and a downlink of the DU may operate simultaneously, and an uplink of the UE and an uplink of the MT may also operate simultaneously. In addition, the technical solutions of this disclosure may be further applied to a distributed antenna system, a repeater system, a multi-carrier concurrent interference-limited system, and the like.

Compared with an example base station communication system, in a full-duplex system, transmit-receive isolating is a particularly important indicator. If the transmit-receive isolating of the system is not properly implemented, a receive channel cannot operate normally during transmission, resulting in decrease in sensitivity of the receive channel. In the case of high power, a front-end amplifier of the receive channel may be damaged. The full-duplex system mainly includes two parts: a radio frequency module and an antenna. The transmit-receive isolating of the full-duplex system is mainly related to antenna isolation and designing of a receive channel and the transmit channel in the radio frequency module. Therefore, the antenna isolation is one of important indicators for measuring performance of the full-duplex system.

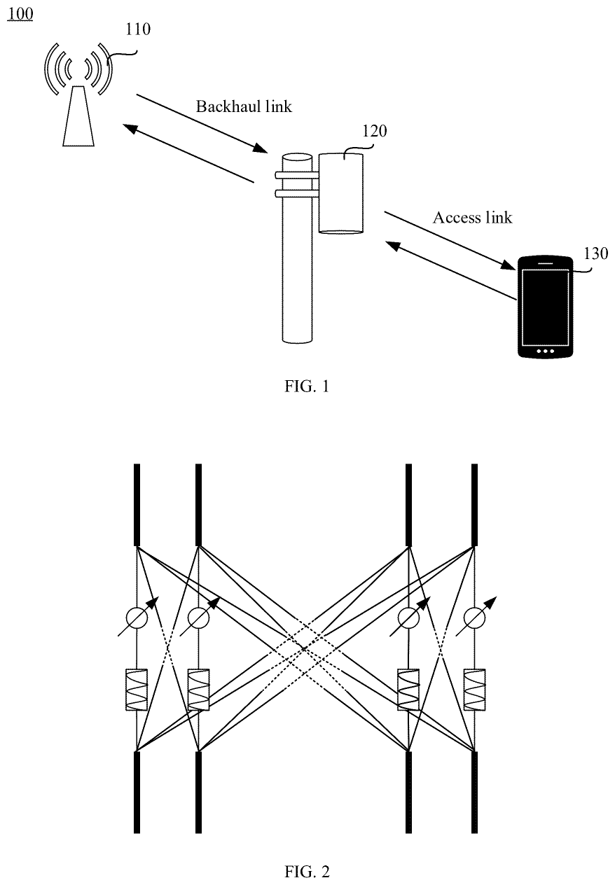

For example, in an IAB system 100 shown in FIG. 1, as a wireless backhaul link, an MT of an IAB device 120 may need to communicate with a base station 110; and as an access link, a DU of the IAB device 120 may need to communicate with user equipment 130. For example, after receiving an uplink communication signal from the user equipment 130, the IAB device 120 may need to process a received signal and then send the processed signal to the base station 110 through an MT antenna. Because the MT antenna and a DU antenna operate in a same slot, if the MT antenna and the DU antenna do not have high isolation, when the MT antenna sends a signal to the base station 110, interference is caused to receiving of the DU antenna. Therefore, in the full-duplex system, high isolation may need to be met between the MT antenna and the DU antenna, to accurately obtain the communication signal sent by the user equipment.

An example high-isolation antenna may focus only on improvement of static isolation (for example, in a microwave anechoic chamber) of the antenna. However, in an example scenario, a surrounding environment of the antenna may cause sharp deterioration of isolation, resulting in performance deterioration. Therefore, how to dynamically adjust the antenna isolation in the example scenario to meet a high isolation characteristic of the antenna in all scenarios is a problem to be resolved.

FIG. 2 is a diagram of an architecture for improving antenna isolation based on a radio frequency circuit. In the architecture shown in FIG. 2, there are a total of 16 channels for air interface coupling paths between antennas including four transmit channels and four receive channels. To eliminate interference of the air interface coupling paths, one cancellation circuit may need to be introduced for each coupling path. The cancellation circuit includes at least one phase shifter and attenuator (FIG. 2 shows a case of four channels). The phase shifter and the attenuator are dynamically adjusted, so that a coupling signal generated by the radio frequency cancellation circuit and a spatial coupling signal have a same amplitude, but opposite phases, to improve isolation between the antennas. Although the antenna architecture shown in FIG. 2 can adapt to different amplitude and phase weights based on an environment change, to implement dynamic adjustment, in a future communication system, as a quantity of channels is increased and an interference path in an environment is added, not only a quantity of air interface coupling paths is increased exponentially, but also quantities of phase shifters and attenuators on each cancellation circuit are also increased sharply. Consequently, the architecture with the cancellation circuit inevitably increases complexity and costs.

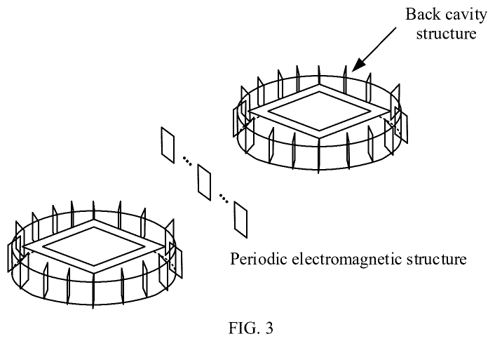

FIG. 3 is a diagram of an architecture for improving isolation between co-frequency transmit and receive antennas. As shown in FIG. 3, the transmit and receive antennas are orthogonal in a polarization mode and are spaced apart at a distance, and a back-cavity structure including a double-layer cylindrical cavity and a radial metal plate is placed below the transmit and receive antennas. The back-cavity structure can suppress propagation of electromagnetic waves in various polarization modes along a surface of the back-cavity structure, to reduce side lobes of the transmit and receive antennas, so as to reduce coupling. In addition, a periodic electromagnetic structure is placed between the transmit and receive antennas. A size and a spacing of the periodic electromagnetic structure are optimized, and amplitudes and phases of a leakage signal and a reflected signal are adjusted for inverse-phase cancellation of the leakage signal and the reflected signal. This further improves the isolation between the antennas. The architecture can resolve problems of signal isolation and self-interference suppression between the co-frequency transmit and receive antennas in a co-frequency full-duplex communication system, and can achieve high isolation between the co-frequency transmit and receive antennas on a large operating bandwidth. Although this solution can improve the isolation between the antennas, an isolation measure is fixed. In other words, only isolation of the antenna itself can be improved, and an interference signal that dynamically changes in an environment cannot be canceled.

To resolve the foregoing problem, this disclosure provides an antenna system, an antenna isolation adjustment method, and an air interface cancellation structure. N air interface cancellation structures between a first antenna array and a second antenna array are adjusted based on information about a communication signal and information about a hybrid signal that are obtained by a feedback circuit in real time, so that the N air interface cancellation structures implement phase adjustment or amplitude and phase adjustment of the transmitted communication signal, to dynamically adjust isolation between radio frequency ports of an antenna. The solution provided in this disclosure can cope with sharp deterioration of antenna isolation caused by a surrounding environment in an example scenario.

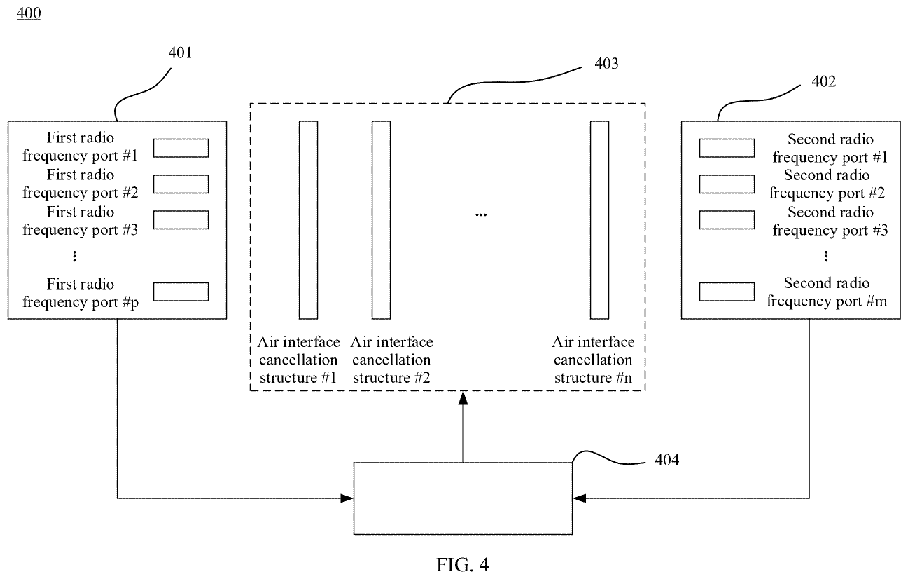

FIG. 4 is a diagram of an architecture of an antenna system 400 according to an embodiment of this disclosure. As shown in FIG. 4, the antenna system 400 includes a first antenna array 401, a second antenna array 402, N air interface cancellation structures 403 (an air interface cancellation structure #1, an air interface cancellation structure #2, . . . , and an air interface cancellation structure #n shown in FIG. 4), and a feedback circuit 404. The first antenna array 401 includes a first radio frequency port set (a first radio frequency port #1, a first radio frequency port #2, . . . , a first radio frequency port #p shown in FIG. 4), and the second antenna array 402 includes a second radio frequency port set (a second radio frequency port #1, a second radio frequency port #2, . . . , a second radio frequency port #m shown in FIG. 4). The N air interface cancellation structures 403 are located between the first antenna array 401 and the second antenna array 402, and the N air interface cancellation structures 403 are sequentially arranged from the first antenna array 401 to the second antenna array 402. The feedback circuit 404 is connected to all of the first antenna array 401, the second antenna array 402, and the N air interface cancellation structures 403. N is an integer greater than or equal to 1.

When the first antenna array 401 serves as a transmitter, the first antenna array 401 is configured to transmit a communication signal. The N air interface cancellation structures 403 are configured to: perform phase adjustment or both phase adjustment and amplitude adjustment on a part of the communication signal transmitted by the first antenna array 401, to generate an adjusted signal; and emit the adjusted signal to the second antenna array 402. The second antenna array 402 is configured to receive a hybrid signal, where the hybrid signal includes the adjusted signal and an interference signal, and the interference signal is a signal generated based on another part of the communication signal. The feedback circuit 404 is configured to: obtain signal information of the communication signal and signal information of the hybrid signal, and adjust isolation between the first radio frequency port set of the first antenna array 401 and the second radio frequency port set of the second antenna array 402 based on to the obtained signal information of the communication signal and the obtained signal information of the hybrid signal.

It should be noted that the signal information of the communication signal or the signal information of the hybrid signal may be an amplitude, a phase, strength, power, and the like of the communication signal or the hybrid signal.

It should be understood that, a part of the communication signal transmitted by the first antenna array 401 reaches the second antenna array 402 after being adjusted by the N air interface cancellation structures, and another part of the communication signal is reflected to the second antenna array through different reflection media. This part of signal that reaches the second antenna array 402 based on communication signal reflection is an interference signal. The interference signal includes but is not limited to a communication signal reflected by an interference path in an environment, or a communication signal reflected by a device itself. In addition, another part of the communication signal transmitted by the first antenna array 401 is received by another device that communicates with a base station in which the first antenna array 401 is located.

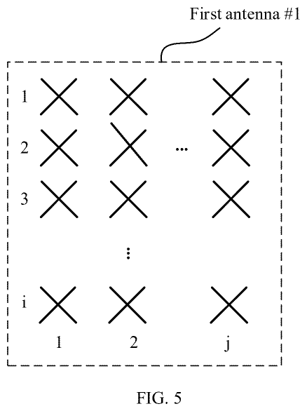

In addition, in this embodiment of this disclosure, the first antenna array 401 includes at least one first antenna, that is, the first antenna array 401 includes one or more first antennas. For example, when the first antenna array 401 includes one first antenna, for example, a first antenna #1, FIG. 5 is a diagram of a structure of the first antenna #1. As shown in FIG. 5, the first antenna #1 may include antenna elements in i rows and j columns, where i and j are integers greater than or equal to 1. The antenna elements in i rows and j columns may be connected to j first radio frequency ports via j one-to-i power dividers. It should be understood that the j first radio frequency ports are j first radio frequency ports in the first radio frequency port set included in the first antenna array 401. In other words, the first radio frequency port set included in the first antenna array 401 includes the j first radio frequency ports. Particularly, when the first antenna #1 includes antenna elements in i rows and one column, the antenna elements in i rows and one column are connected to one first radio frequency port in the first radio frequency port set via one one-to-i power divider. Similarly, the second antenna array 402 also includes at least one second antenna. Each of the at least one second antenna may include antenna elements in p rows and m columns, and is connected to m second radio frequency ports via m one-to-p power dividers, where p and m are integers greater than or equal to 1. It should be understood that, when a quantity of rows and a quantity of columns are changed, FIG. 5 may also be considered as a structure of the second antenna.

In the solution of this disclosure, there is an isolation region between the first antenna array 401 and the second antenna array 402, and the isolation region is used to place the N air interface cancellation structures 403. In other words, the region occupied by the N air interface cancellation structures 403 may be referred to as the isolation region, that is, a distance between a 1^{st} air interface cancellation structure and an N^{th} air interface cancellation structure is referred to as the isolation region. At least one air interface cancellation structure is included in the isolation region. The 1^{st} air interface cancellation structure to the N^{th} air interface cancellation structure in the N air interface cancellation structures are sequentially arranged from one end that is of the first antenna array 401 and that is close to the isolation region to one end that is of the second antenna array 402 and that is close to the isolation region.

It should be understood that the N air interface cancellation structures 403 placed in the isolation region are configured to adjust the isolation between the first radio frequency port set of the first antenna array 401 and the second radio frequency port set of the second antenna array 402. Therefore, the isolation region is located on a coupling path between the first radio frequency port set and the second radio frequency port set. For example, when the first radio frequency port set includes four first radio frequency ports, and the second radio frequency port set includes eight second radio frequency ports, 32 coupling paths are included between the first antenna array 401 and the second antenna array 402. In this case, the N air interface cancellation structures 403 are configured to adjust isolation of the 32 coupling paths, so that the isolation of the 32 coupling paths may meet a preset requirement.

It should be further understood that isolation between antennas or antenna elements in the first antenna array 401 is not limited in this disclosure. Similarly, there may be no high isolation between antennas or antenna elements in the second antenna array 402, or there may be high isolation between antennas or antenna elements in the second antenna array 402. This is not limited in this disclosure.

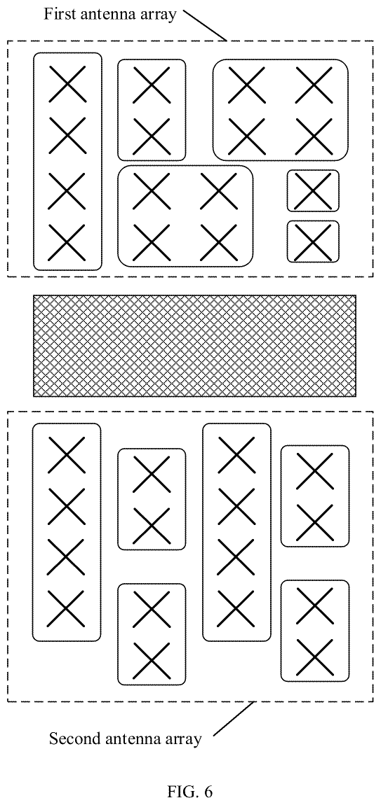

It should be further noted that a quantity and an arrangement manner of antennas (or antenna elements) included in the first antenna array 401 or the second antenna array 402 may be designed or arranged based on a system requirement. In other words, the antennas (or antenna elements) in the first antenna array 401 or the second antenna array 402 are not necessarily arranged according to a periodic arrangement rule. In other words, the arrangement manner of the antennas (or antenna elements) in the first antenna array 401 may be different from the arrangement manner of the antennas (or antenna elements) in the second antenna array 402. This is not limited in this disclosure. In addition, when the first antenna array 401 includes j first radio frequency ports, antenna elements corresponding to the j first radio frequency ports may be divided in a variety of manners. That is, in the solution of this disclosure, a manner of dividing the radio frequency ports included in the first antenna array 401 and the second antenna array 402 is not limited in this disclosure, and division may be performed based on different location relationships or application scenarios. For example, in FIG. 6, the first antenna array includes six first radio frequency ports, and quantities of antenna elements corresponding to the radio frequency ports are different. Similarly, FIG. 6 shows a possible division manner of second radio frequency ports (e.g., six) included in the second antenna array 402.

It should be noted that a length of the isolation region is related to a wavelength of the communication signal. In some embodiments, the length of the isolation region is greater than 1 time the wavelength of the communication signal. Optionally, the length of the isolation region is 1 time to 1.5 times the wavelength of the communication signal.

It should be further noted that a distance between the 1^{st} air interface cancellation structure (namely, an air interface cancellation structure closest to the first antenna array 401) and the first antenna array 401, and a distance between the N^{th} air interface cancellation structure (namely, an air interface cancellation structure closest to the second antenna array 402) and the second antenna array 402 are related to the wavelength of the communication signal. In some embodiments, a maximum distance between the 1^{st} air interface cancellation structure in the N air interface cancellation structures 403 and an edge of the first antenna array 401 is 0.25 time the wavelength of the communication signal. Similarly, a maximum distance between the N^{th} air interface cancellation structure in the N air interface cancellation structures 403 and an edge of the second antenna array 402 is 0.25 time the wavelength of the communication signal. Particularly, when there is one air interface cancellation structure between the first antenna array 401 and the second antenna array 402, the one air interface cancellation structure may be designed at any location between the first antenna array 401 and the second antenna array 402, for example, may be disposed in the middle between the first antenna array 401 and the second antenna array 402.

In addition, all of the N air interface cancellation structures 403 have a same width and height. A line length of a cross section of each air interface cancellation structure is 0.2 time to 0.6 time the wavelength of the communication signal.

In addition, a width of each air interface cancellation structure is related to a width of the first antenna array 401 and a width of the second antenna array 402. A height of each air interface cancellation structure is related to the wavelength of the communication signal. In some embodiments, the width of each air interface cancellation structure is a larger value of the width of the first antenna array 401 and the width of the second antenna array 402. Alternatively, in some other embodiments, the width of each air interface cancellation structure is greater than a larger value of the width of the first antenna array 401 and the width of the second antenna array 402. The width of the air interface cancellation structure is designed to be greater than or equal to the width of the antenna array, so that transmitted signals of the first antenna and the second antenna can be obtained to a maximum extent, to improve an adjustment capability and improve isolation between the antennas.

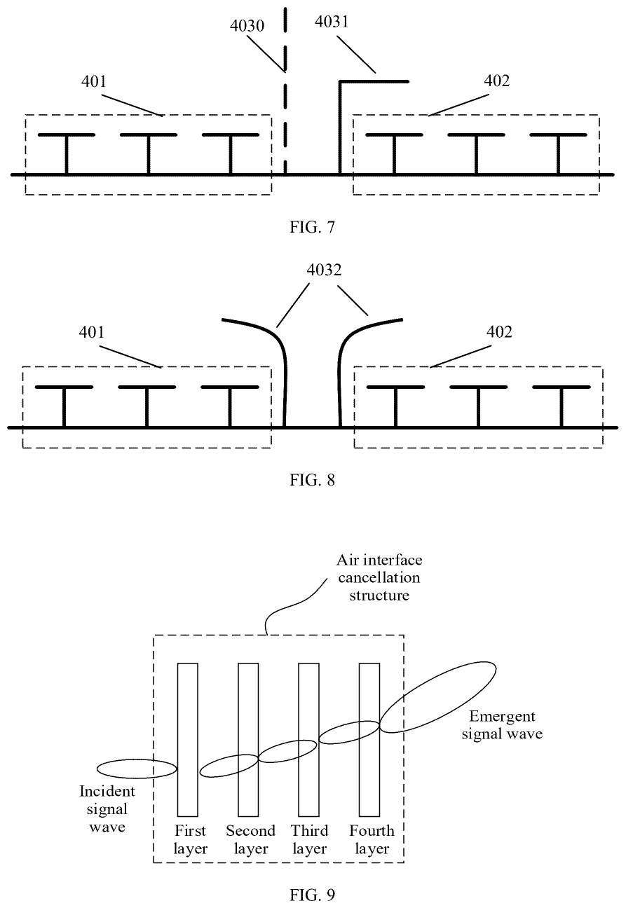

To further improve isolation of the antenna, reduce a profile, and enhance cancellation effect of the air interface cancellation structure 403 on the interference path, a vertical structure of each air interface cancellation structure shown in FIG. 4 may be changed to a curved shape that has stronger wrapping performance for the communication signal. In an implementation, the cross section of each air interface cancellation structure may be bent into a right-angle L-shaped structure shown in FIG. 7. Alternatively, in another implementation, each air interface cancellation structure may be designed as an air interface cancellation structure 4032 that is of an arc-shaped L structure and that is shown in FIG. 8.

It should be noted that, in this embodiment of this disclosure, the line length of the cross section of the air interface cancellation structure should be understood as a length of the cross section of the air interface cancellation structure. When the air interface cancellation structure is not bent, for example, 4030 shown in FIG. 7, the height of the air interface cancellation structure is the line length of the cross section of the air interface cancellation structure. When the air interface cancellation structure is bent, for example, is an L-shaped structure shown in FIG. 7 or FIG. 8, the line length of the cross section of the air interface cancellation structure includes a length of a curve bent toward the antenna array in FIG. 7 or FIG. 8, namely, a curve length of the cancellation structure shown in FIG. 7 or FIG. 8.

In the solution of this disclosure, each of the N air interface cancellation structures 403 includes at least one layer. In other words, each of the N air interface cancellation structures 403 is a single-layer structure or a multi-layer structure. For example, when N is 3, the air interface cancellation structure 403 includes a 1^{st} air interface cancellation structure closest to the first antenna array 401, a 3^{rd} air interface cancellation structure closest to the second antenna array 402, and a 2^{nd} air interface cancellation structure located between the 1^{st} air interface cancellation structure and the 3^{rd} air interface cancellation structure. All of the three air interface cancellation structures may be single-layer or multi-layer, or a part of the three air interface cancellation structures are single-layer and a part of the three air interface cancellation structures are multi-layer. In an implementation, when a single air interface cancellation structure includes a plurality of layers, a multi-layer coupling structure shown in FIG. 9 may be used. The multi-layer coupling structure may be considered as an entire structure and operate together. When an incident signal wave (for example, the communication signal sent by the first antenna array) is incident to the multi-layer coupled air interface cancellation structure, a first layer may adjust an amplitude of the incident signal wave, and a second layer to a fourth layer may adjust a phase of the incident wave. It should be understood that the four-layer coupling structure shown in FIG. 9 is merely an example rather than a limitation. In another embodiment, the multi-layer coupled air interface cancellation structure may alternatively be a coupling structure including another quantity of layers, for example, two layers, three layers, or more layers.

In addition, in the solution of this disclosure, each of the N air interface cancellation structures includes a plurality of resonance elements. When the air interface cancellation structure includes a plurality of layers, each layer includes a plurality of resonance elements. Each resonance element includes a positive electrode and a negative electrode. In addition, each resonance element further includes at least one switch, at least one varactor diode, or another voltage-controlled element. Positive electrodes of the plurality of resonance elements in each air interface cancellation structure are configured to control the resonance elements respectively. Optionally, negative electrodes of the plurality of resonance elements in each air interface cancellation structure may be connected together, for example, are all ground ends.

It should be noted that, in the solution of this disclosure, at least one layer of each air interface cancellation structure includes k switches or k varactor diodes, and k satisfies k>max(j,m), where j is a quantity of first radio frequency ports in the first radio frequency port set, m is a quantity of second radio frequency ports in the second radio frequency port set, and both j and m are integers greater than or equal to 1. For example, when the first antenna array is designed in the arrangement manner shown in FIG. 5, to be specific, when the first radio frequency port is divided based on a quantity of columns of the first antenna array, the quantity of first radio frequency ports is the quantity of columns of the first antenna array 401, and correspondingly, the quantity of second radio frequency ports is a quantity of columns of the second antenna array 402; or when the first radio frequency port is divided based on a quantity of rows of the first antenna array 401, the quantity of first radio frequency ports is the quantity of rows of the first antenna array 401, and correspondingly, the quantity of second radio frequency ports is a quantity of rows of the second antenna array 402.

To implement phase adjustment on the communication signal, or implement both phase adjustment and amplitude adjustment on the communication signal, in the solution of this disclosure, the resonance elements included in the air interface cancellation structure may be classified into a phase resonance element and an amplitude resonance element. The amplitude resonance element is configured to adjust an amplitude of the signal, and the phase resonance element is configured to adjust a phase of the signal.

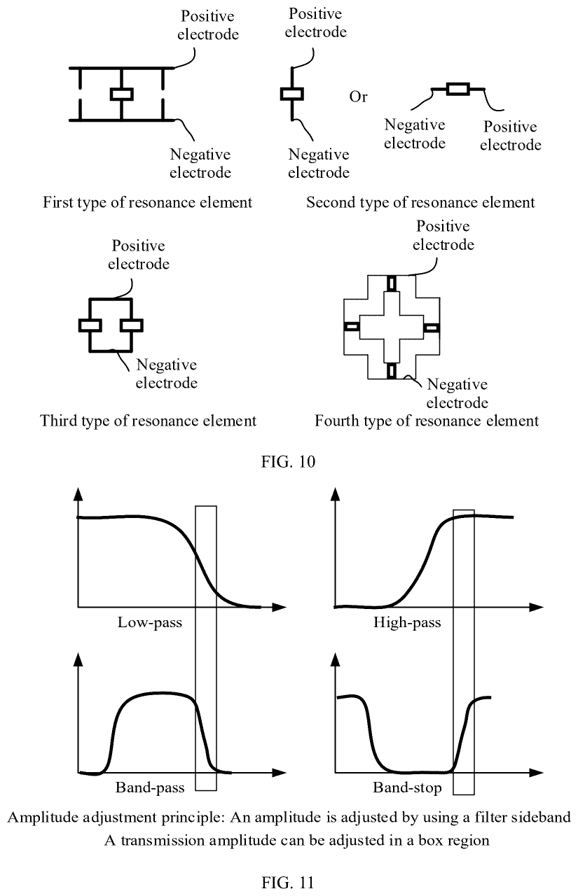

FIG. 10 is a diagram of structures of four possible amplitude resonance elements according to an embodiment of this disclosure. The amplitude resonance element may implement one of four types of adjustment: band-pass adjustment, band-stop adjustment, low-pass adjustment, and high-pass adjustment via a resonance structure. As shown in FIG. 11, a transition band (that is, from a passband to a stopband or from a stopband to a passband) of a filter is located at a location of an operating frequency band. Therefore, a resonant frequency may be adjusted (that is, a location of the transition band is adjusted) by adjusting a resonance element switch or the varactor diode, to control energy of a transmitted electromagnetic wave.

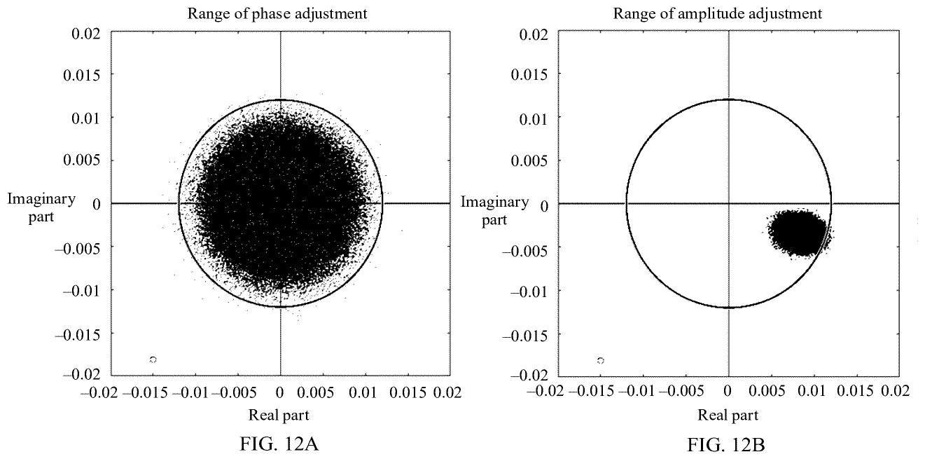

FIGS. 12A and 12B are diagrams of cancellation capabilities of a phase resonance element and an amplitude resonance element for an interference path according to an embodiment of this disclosure. FIGS. 12A and 12B are described by using a Smith chart. It is assumed that the amplitude of the hybrid signal generated due to introduction of the interference path in the environment is not greater than 0.012 (which may be referred to as a transmission coefficient, is a ratio of a voltage amplitude of the hybrid signal to a voltage amplitude of the transmitted communication signal, and is not greater than 0.012). Because external interference in an operating scenario is complex and changeable, the hybrid signal to be canceled by the air interface cancellation structure is theoretically randomly distributed, that is, may be located at any coordinate location in a circle with a radius of 0.012 on a complex plane. In addition, when locations of the N air interface cancellation structures are fixed, a wave path between the first radio frequency port and the resonance element in the air interface cancellation structure is also fixed. Because a diameter of a surface of the air interface cancellation structure is small, and a spacing between the antenna and the air interface cancellation structure is short, an original wave path difference between resonance elements is small, and a phase difference is also small. In addition, strength of an electromagnetic wave received by the second antenna array is low. Therefore, if only the amplitude resonance element is used, the amplitude resonance element always reduces an amplitude of an adjustment wave, and reduces an amplitude range within which the air interface cancellation structure can perform cancellation. As a result, a total transmission coefficient obtained through amplitude-weighted superposition may have only a phase value near a small phase range, and it is difficult to implement full coverage of 360° within the radius of 0.012 in the Smith chart. Compared with the amplitude resonance element that can only scale a module of each sub-vector, and cannot change a direction of a vector, and consequently it is difficult for a direction of a total vector to appear outside each sub-vector direction, the phase resonance element can enable each sub-vector to rotate around an origin, and therefore, the direction of the total vector may appear in any direction (corresponding to a better phase coverage capability), that is, the phase resonance element can implement more complete superposition and cancellation. FIG. 12A shows 4-bit discrete random distribution in which an amplitude of a transmission coefficient of the phase resonance element is 1 and an adjustable phase is [0°: 22.5°: 360°]; and FIG. 12B shows discrete random distribution in which an amplitude of a transmission coefficient of the amplitude resonance element is [0: 0.1:1] and a phase is 0°. That is, in the Smith chart, the phase resonance element can cancel the interference signal at almost all discrete points in the Smith chart with an amplitude of 0.012, so that a cancellation range for the interference path in an example scenario can be greatly increased. It is assumed that 0.012 in the Smith chart corresponds to a coupled signal of −38 decibels (dB). If target isolation is −50 dB, a location at which the hybrid signal randomly appears is within a small circle with a radius of 0.0032, and may be considered as a point. Therefore, it may be understood that when the phase resonance element is used for adjustment, interference at any location within a circle with a radius of 0.012 can be canceled.

In some embodiments, the phase resonance element may include a plurality of layers, and each of the plurality of layers has specific phase adjustment. The phase of the transmitted communication signal is adjusted through superposition of a multi-layer structure, to achieve an adjustment range of 0 degrees to 360 degrees.

When the air interface cancellation structure between the first antenna array 401 and the second antenna array 402 is used to adjust the amplitude of the communication signal, a plurality of resonance elements in the N air interface cancellation structures 403 may be at least one type of resonance elements in the resonance elements shown in FIG. 10, and the resonance elements in the air interface cancellation structures may be the same or different. For example, when there are three air interface cancellation structures between the first antenna array 401 and the second antenna array 402: a first air interface cancellation structure, a second air interface cancellation structure, and a third air interface cancellation structure, the first air interface cancellation structure, the second air interface cancellation structure, and the third air interface cancellation structure include a plurality of same resonance elements, and the plurality of resonance elements may all be any one type of resonance elements in the four types of resonance elements. The plurality of resonance elements in the first air interface cancellation structure are of one of the four types shown in FIG. 10, the plurality of resonance elements in the second air interface cancellation structure are of one of the four types shown in FIG. 10, and the plurality of resonance elements in the third air interface cancellation structure are of one of the four types shown in FIG. 10. In addition, the first air interface cancellation structure, the second air interface cancellation structure, and the third air interface cancellation structure resonance element may not necessarily use a same structure. The resonance element in the first air interface cancellation structure, the resonance element in the second air interface cancellation structure, and the resonance element in the third air interface cancellation structure may all be the same or different, or two of them may be the same.

In some embodiments, the plurality of resonance elements in each air interface cancellation structure include at least one resonance element (phase resonance element) for phase adjustment.

It should be noted that, when the first antenna array 401 includes j first radio frequency ports, and the second antenna array 402 includes m first radio frequency ports, the N air interface cancellation structures may need to include at least j*m resonance elements for phase adjustment.

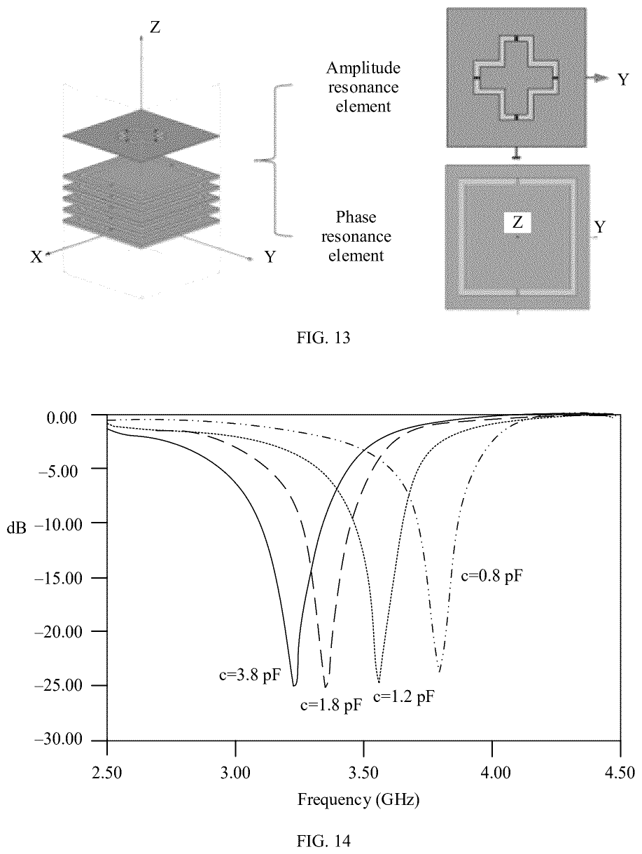

When each of the N air interface cancellation structures is multi-layered, each layer in the multi-layer air interface cancellation structure includes a plurality of resonance elements. In this case, the multi-layer air interface cancellation structure may also be considered as a whole, and the plurality of resonance elements included in the multi-layer air interface cancellation structure are considered as resonance of a multi-layer structure shown in FIG. 13. A first layer of the resonance element of the multi-layer structure is configured to adjust the amplitude of the communication signal, and another layer is configured to adjust a phase of the signal after amplitude adjustment. It should be understood that the first layer of resonance element of the multi-layer structure may be of any one of the four types shown in FIG. 10. Another layer in the resonance element of the multi-layer structure may be a phase adjustment unit shown in FIG. 13, or a phase adjustment unit in another form.

It should be noted that, when the air interface cancellation structure is multi-layered, at least one phase resonance element included in the air interface cancellation structure may be at any location in the plurality of layers. This is not limited in this disclosure.

It should be noted that the resonance elements shown in FIG. 10 and FIG. 13 are merely examples rather than limitations. In the solutions of this disclosure, designing of an amplitude adjustment unit for amplitude adjustment and a phase adjustment unit for phase adjustment is not limited, provided that sizes of the amplitude adjustment unit and the phase adjustment unit meet a relationship with a communication wavelength.

In some embodiments, when a first type of resonance element shown in FIG. 10 is used to form the air interface cancellation structure, the resonance element belongs to an inductive-capacitive resonator, and includes an inductor loop and a capacitor gap. The resonance element may be printed on a glass fiber and epoxy resin copper-clad substrate with a dielectric constant of 4.4 and a thickness of 1 millimeter (mm), and broadband tuning can be implemented by loading a varactor diode at a specific location of the resonator. Optimal tunability may be achieved by placing the varactor diode at a location with a maximum voltage gradient or a maximum absolute current induced by an incident wave. For the electrically coupled inductive-capacitive resonator, the maximum voltage gradient occurs in the middle of a middle strip. Therefore, the varactor diode may be placed in the middle of the middle strip, and a capacitance change range of the varactor diode is usually from 0.54 picofarad (pF) to 6.6 pF. When the wavelength and the phase of the incident communication signal are adjusted, a bias voltage of the varactor diode is changed, to control an operating center frequency of the air interface cancellation structure, so that a transmission coefficient or a reflection coefficient of the air interface cancellation structure is changed, to adjust the wavelength and the phase of the incident communication signal. For example, FIG. 14 shows change curves of the transmission coefficient of the air interface cancellation structure in a case in which the varactor diode is at different capacitances. It can be seen from FIG. 14 that, within a change range of the varactor diode, the transmission coefficient of the air interface cancellation structure may be dynamically adjusted from 3.2 gigahertz (GHz) to 4.2 GHz.

In some embodiments, each layer of each air interface cancellation structure includes periodically arranged resonance elements. For example, each layer of each air interface cancellation structure includes resonance elements in p rows and q columns. The resonance elements are periodically arranged, so that space of the air interface cancellation structure can be saved, and the resonance elements in the air interface cancellation structure can be properly arranged.

It should be understood that the resonance elements included in each layer of each air interface cancellation structure may be aperiodically arranged, and an arrangement manner of the resonance elements may be designed differently based on an application scenario. This is not limited in this disclosure.

It should be noted that a length of the resonance element is related to the wavelength of the communication signal. In some embodiments, a long side of each resonance element is 0.2 time to 0.3 time the wavelength of the communication signal.

It should be noted that, in this embodiment of this disclosure, an example in which the first antenna array 401 is used as a transmit antenna array and the second antenna array is used as a receive antenna array is used for description. This does not limit the protection scope of this disclosure. It should be understood that, in a full-duplex system, the first antenna array 401 may also be used as a receive antenna array, and correspondingly, the second antenna array 402 may also be used as a transmit antenna array. The solution in this disclosure may also be used to eliminate interference caused by a communication signal sent by the second antenna array 402 to an external device (for example, UE) to a communication signal that is received by the first antenna array 401 and that is from an external device (for example, a base station).

Based on the foregoing solution, in the antenna system provided in this disclosure, the air interface cancellation structure can avoid a large quantity of phase shifters and attenuators introduced when a complex cancellation circuit is used, and can simplify a solution for suppressing the antenna interference path. A circuit cancellation structure is changed to the air interface cancellation structure, to greatly reduce complexity and costs.

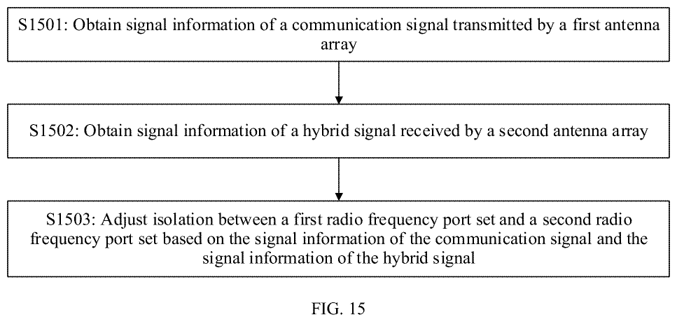

FIG. 15 is a schematic flowchart of an isolation adjustment method 1500 according to an embodiment of this disclosure. The method can be applied to the antenna system 400 shown in FIG. 4, and is performed by the feedback circuit 404. The method includes the following steps.

S1501: Obtain signal information of a communication signal transmitted by a first antenna array.

The feedback circuit 404 obtains the signal information of the communication signal transmitted by the first antenna array 401.

S1502: Obtain signal information of a hybrid signal received by a second antenna array.

The feedback circuit 404 obtains the signal information of the hybrid signal received by the second antenna array 402, where the hybrid signal includes an adjusted signal and an interference signal, the adjusted signal is generated by performing phase adjustment or both phase adjustment and amplitude adjustment on a part of the communication signal by N air interface cancellation structures, and the interference signal is generated based on another part of the communication signal.

S1503: Adjust isolation between a first radio frequency port set and a second radio frequency port set based on the signal information of the communication signal and the signal information of the hybrid signal.

After obtaining the signal information of the communication signal and the signal information of the hybrid signal, the feedback circuit 404 adjusts transmission coefficients or reflection coefficients of the N air interface cancellation structures 403 based on the signal information of the communication signal and the signal information of the hybrid signal, to change the isolation between the first radio frequency port set of the first antenna array 401 and the second radio frequency port set of the second antenna array 402.

In some embodiments, that the feedback circuit 404 adjusts the transmission coefficients or reflection coefficients of the N air interface cancellation structures 403 based on the signal information of the communication signal and the signal information of the hybrid signal includes: The feedback circuit 404 calculates initial isolation between the first radio frequency port set and the second radio frequency port set based on the signal information of the communication signal and the signal information of the hybrid signal, and generates bias voltages of a plurality of resonance elements in each of the N air interface cancellation structures 403 based on the initial isolation between the first radio frequency port set and the second radio frequency port set. The transmission coefficient or reflection coefficient of each of the N air interface cancellation structures 403 is changed by adjusting the bias voltages of the plurality of resonance elements, to adjust the isolation between the first radio frequency port set and the second radio frequency port set.

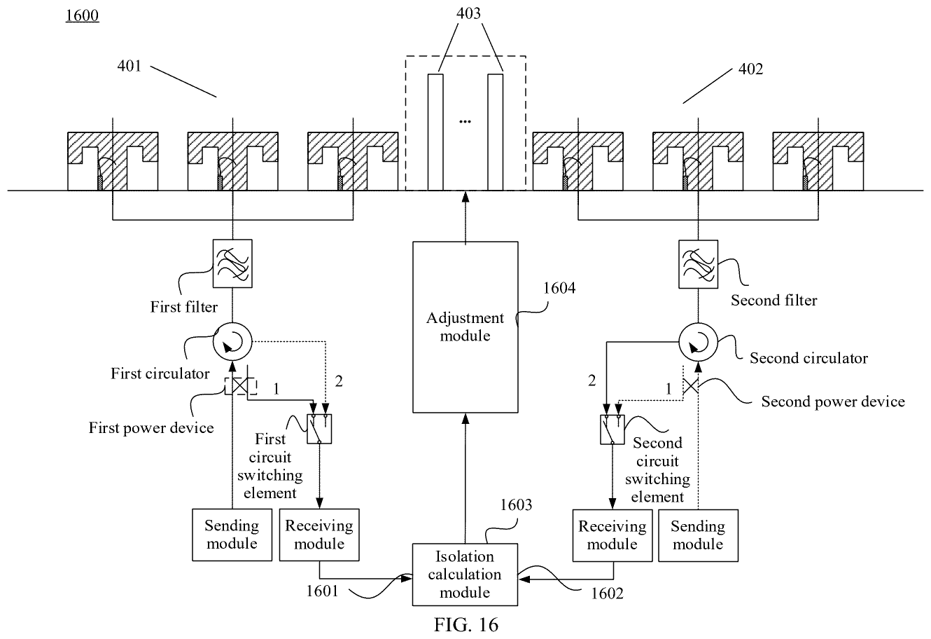

FIG. 16 is a diagram of a structure of a feedback circuit according to an embodiment of this disclosure. The feedback circuit includes a first input end 1601, a second input end 1602, an isolation calculation module 1603, and an adjustment module 1604. The first input end 1601 is connected to a first radio frequency port (for example, a first radio frequency port #1) in a first radio frequency port set via a first power device and a first circuit switching element, and the second input end 1602 is connected to a second radio frequency port (for example, a second radio frequency port #1) in a second radio frequency port set via a second power device and a second circuit switching element. The first input end 1601 and the second input end 1602 are used as input ends of the isolation calculation module 1603, and the isolation calculation module 1603 is connected to the adjustment module 1604. The adjustment module 1604 is connected to N air interface cancellation structures. When a sending module connected to the first radio frequency port #1 sends a communication signal, the communication signal is divided into two paths of signals by the first power device (which may also be referred to as a power divider), and the first circuit switching element is biased to a line connected to the first power device. Therefore, one path of signal obtained through division of the power device passes through a circulator, and reaches the first radio frequency port #1 via a filter for transmission. The other path of divided communication signal is input into a receiving module of the first radio frequency port #1 via the first circuit switching element, and the receiving module of the first radio frequency port #1 measures information (for example, an amplitude and a phase) of the divided communication signal, and transmits a measurement result to the isolation calculation module 1603 and the first input end 1601. When the second radio frequency port #1 receives a hybrid signal, the second circuit switching element is biased to a line connected to a second circulator, and the hybrid signal received by the second radio frequency port #1 is input into a receiving module of the second radio frequency port #1 via the second circuit switching element. The receiving module of the second radio frequency port #1 measures information (for example, an amplitude and a phase) of the received hybrid signal, and transmits a measurement result to the isolation calculation module 1603 and the second input end 1602. The isolation calculation module 1603 calculates initial isolation based on the signal information of the communication signal and the signal information of the hybrid signal that are obtained by the first input end 1601 and the second input end 1602, and transmits the initial isolation to the adjustment module 1604. The adjustment module 1604 adjusts transmission coefficients or reflection coefficients of the N air interface cancellation structures based on the received initial isolation, to change the isolation between the first radio frequency port set and the second radio frequency port set.

Optionally, the first power device is a power divider or a coupler. This is not limited in this disclosure.

Optionally, the first circuit switching element and the second circuit switching element are single-pole double-throw switches (as shown in FIG. 16). In some embodiments, the first circuit switching element and the second circuit switching element may alternatively be replaced with circuit switching elements such as triodes or couplers. This is not limited in this disclosure.

The first radio frequency port #1 and the second radio frequency port #1 are still used as examples to describe functions of the first circuit switching element and the second circuit switching element in this disclosure. As shown in FIG. 16, when the first circuit switching element is connected to a branch 1, the receiving module corresponding to the first radio frequency port #1 obtains, via the first circuit switching element, signal information of a communication signal sent by the first radio frequency port #1, and transmits, to the isolation calculation module 1603, the signal information of the communication signal sent by the first radio frequency port #1. In this case, the second circuit switching element of the second radio frequency port #1 is connected to a branch 2, and is configured to: obtain a hybrid signal via the second circulator, and transmit the hybrid signal to the isolation calculation module 1603. When the first circuit switching element is connected to a branch 2, the receiving module corresponding to the first radio frequency port #1 obtains, via the first circuit switching element, signal information of a communication signal (from another communication device, for example, a terminal device) received by the first radio frequency port #1. In this case, the second circuit switching element of the second radio frequency port #1 is connected to a branch 1, and the receiving module corresponding to the second radio frequency port #1 obtains, via the second power device, signal information of a communication signal sent by the second radio frequency port #1. In conclusion, in the solution of this disclosure, sharing of the receiving module corresponding to the first radio frequency port #1 or the receiving module corresponding to the second radio frequency port #1 during isolation calculation can be implemented via the first circuit switching element and the second circuit switching element. This reduces a quantity of receiving devices in a system.

Optionally, the isolation calculation module 1603 may be an intermediate-frequency application-specific integrated circuit (ASIC) chip, or an application module in an ASIC chip, or may be a field-programmable gate array (FPGA), a complex programmable logic device (CPLD), or another application module that can implement logic determining. This is not limited in this disclosure.

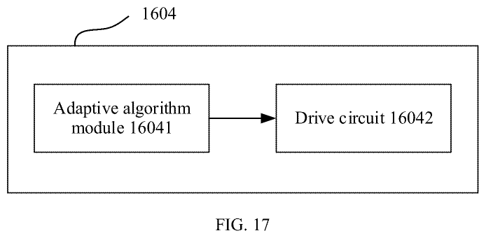

In some embodiments, as shown in FIG. 17, the adjustment module 1604 includes an adaptive algorithm module 16041 and a drive circuit 16042. After receiving the initial isolation information, the adaptive algorithm module 16041 performs an optimization operation, and changes a bias voltage of each resonance element in the N air interface cancellation structures via the drive circuit 16042, to change the transmission coefficients or reflection coefficients of the N air interface cancellation structures, thereby changing the isolation between the first radio frequency port and the second radio frequency port.

It should be noted that, when the system is in a specific scenario (for example, a horizontal bar is blocked), after the N air interface cancellation structures are dynamically adjusted each time, an isolation indicator may be monitored once. In addition, with isolation maximization as an optimization objective, a bias voltage of each resonance element in the N air interface cancellation structures is adjusted in real time to adjust parameters of the N air interface cancellation structures, and a status of the N air interface cancellation structures that meets isolation maximization is searched for according to an algorithm.

Optionally, the adaptive algorithm module 16041 may be implemented by an FPGA, or may be implemented as an algorithm module in an FPGA, or may be implemented according to an algorithm in a complex CPLD. This is not limited in this disclosure. The drive circuit 16042 may be implemented by a parallel dynamic channel allocation (DCA) drive circuit.

It should be understood that the feedback circuit is a feedback iteration loop. In other words, adaptive optimization of isolation in a complex environment is implemented through forward feedback iteration. When isolation calculated by the isolation calculation module meets a requirement, the isolation calculation module periodically calculates the isolation between antennas, temporarily stops controlling the air interface cancellation circuit, and stabilizes the parameter of the air interface cancellation circuit.

It should be noted that FIG. 16 is described only by using a first antenna array 401 as a transmitter and a second antenna array 402 as a receiver. It should be understood that, in a full-duplex system, both the first antenna array 401 and the second antenna array 402 may be used as the transmitter and the receiver, that is, the first antenna array 401 and the second antenna array 402 are dual-polarized antenna arrays. When the first antenna array 401 is used as the receiver and the second antenna array 402 is used as the transmitter, refer to the foregoing description for this process. Details are not described herein.

It should be further noted that FIG. 16 shows only a case in which the first antenna array 401 includes one first radio frequency port and the second antenna array 402 includes one second radio frequency port. It should be understood that when each of the first radio frequency port set of the first antenna array 401 and the second radio frequency port set of the second antenna array 402 includes a plurality of radio frequency ports, there is one feedback circuit for each coupling path between a transmit radio frequency port and a receive radio frequency port.

Based on the foregoing solution, a coupling circuit is added between a transmit channel and a receive channel, and a circuit switching element monitors signal information of the transmit channel in real time via the coupling circuit, so that isolation can be monitored in real time, and the isolation between the transmit channel and the receive channel may be dynamically adjusted based on a service requirement. In addition, in the solution provided in this disclosure, the transmitted communication signal is sent to the receiving module via a power divider, so that signals transmitted through a plurality of transmit channels can be simultaneously detected. The circuit switching element can further save one receive channel, thereby reducing costs, and improving measurement efficiency.

To describe technical effect of embodiments of this disclosure, the following describes the solutions provided in this disclosure by using an antenna system 1800 shown in FIG. 15 as an example.

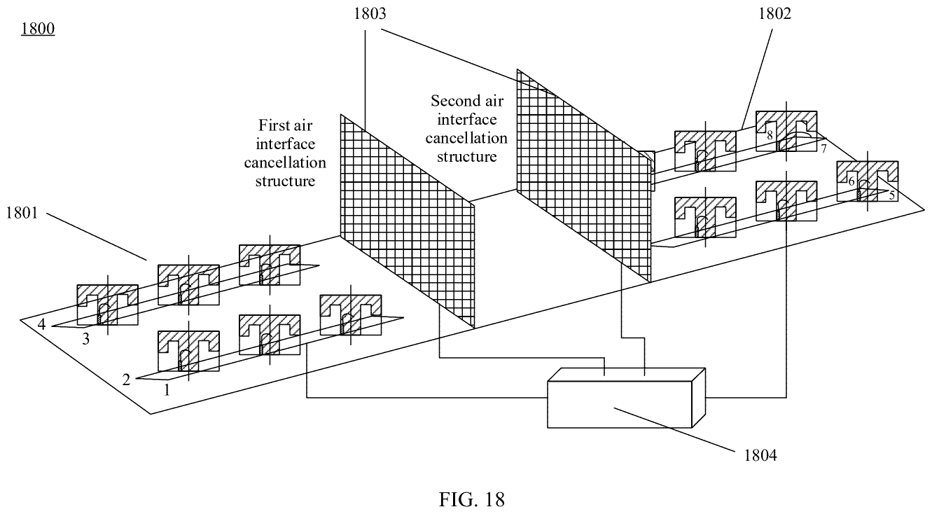

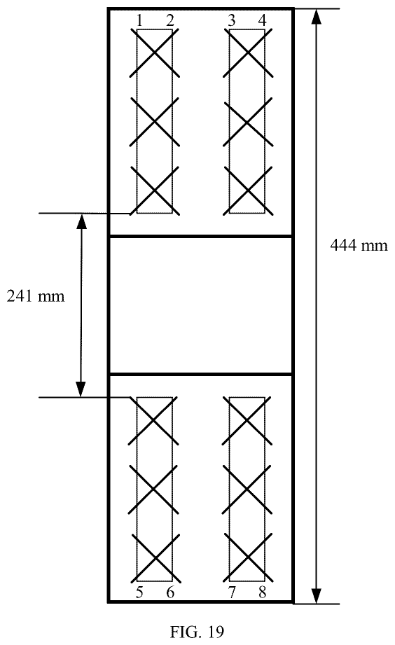

As shown in a 3D diagram of a system shown in FIG. 18, a 4×4 dual-polarized antenna array is designed. A first antenna array 1801 includes two columns of dual-polarized antenna elements, and antenna elements with same polarization are connected via a one-to-three power divider. In addition, a first radio frequency port set includes four ports: a first radio frequency port 1, a first radio frequency port 2, a first radio frequency port 3, and a first radio frequency port 4. Correspondingly, a second antenna array 1802 includes two columns of dual-polarized antenna elements, and antenna elements with same polarization are connected via a one-to-three power divider. In addition, a second radio frequency port set includes four ports: a second radio frequency port 5, a second radio frequency port 6, a second radio frequency port 7, and a second radio frequency port 8. A top view of the first antenna array 1801 and the second antenna array 1802 is shown in FIG. 19. A length of the antenna array is 444 mm, and is approximately 5.2λ, where λ is a wavelength of a 3.5 GHz communication signal. A distance between two antenna arrays is 241 mm, and is approximately 2.8λ. Because the first antenna array and the second antenna array are dual-polarized antenna arrays, there are 16 coupling paths between the first antenna array and the second antenna array.

To reduce difficulty in coupling analysis, coupling types between dual-polarized antenna arrays may be first classified. Based on relative spatial locations of the dual-polarized antenna arrays, 16 types of coupling may be mainly classified into the following four types of coupling: (1) co-polarization coupling of same columns: S15, S26, S37, and S48; (2) hetero-polarization coupling of same columns: S16, S25, S38, and S47; (3) co-polarization coupling of adjacent columns: S17, S46, S28, and S35; and (4) hetero-polarization coupling of adjacent columns: S18, S27, S36, and S45.

When a reflection coefficient of each port is simulated based on a perfectly matched layer (PML) boundary condition, the reflection coefficient of each port is lower than −15 dB in a frequency band from 3.3 GHz to 3.8 GHz. Simulation results of the foregoing five different types of coupling show that each type of coupling is approximately lower than −50 dB in the entire frequency band from 3.3 GHz to 3.8 GHz.

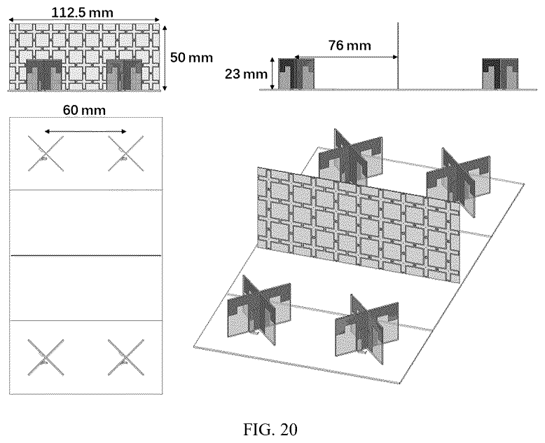

It should be noted that electric field distribution of the foregoing four different types of couplings gradually attenuates as the distance between the first antenna array 1801 and the second antenna array 1802 increases. Therefore, when the distance between the two antenna arrays is 2.8λ, because the distance is no longer a near-field distance, an electric field of the first antenna array 1801 is extremely weak after reaching the second antenna array 1802, and the air interface cancellation structure may need to be disposed at a location close to the antenna array. After optimization, a 1^{st} air interface cancellation structure is disposed at a location that is 0.25λ away from the first antenna array 1801, and a 2^{nd} air interface cancellation structure is disposed at a location that is 0.25λ away from the second antenna array 1802. That is, when the air interface cancellation structure is arranged at the location that is approximately 0.25λ away from the first antenna array 1801, impact of the air interface cancellation structure on the antenna element can be reduced, and sufficient coupled electromagnetic waves can be intercepted. FIG. 20 is a diagram of a structure of an air interface cancellation structure used in the antenna system 1800 and a diagram of system parameters used in the air interface cancellation structure. As shown in FIG. 18, the air interface cancellation structure includes resonance elements that are periodically arranged in four rows and nine columns. The air interface cancellation structure may be used between dual-polarized antenna arrays that include four transmit ports and four receive ports. A profile height of an antenna element is 23 mm, and a spacing is 60 mm. The air interface cancellation structure is separately disposed at a location that is 76 mm away from a center of a transmit antenna and a center of a receive antenna, and a length and a width of the air interface cancellation structure are 112.5 mm and 50 mm respectively.

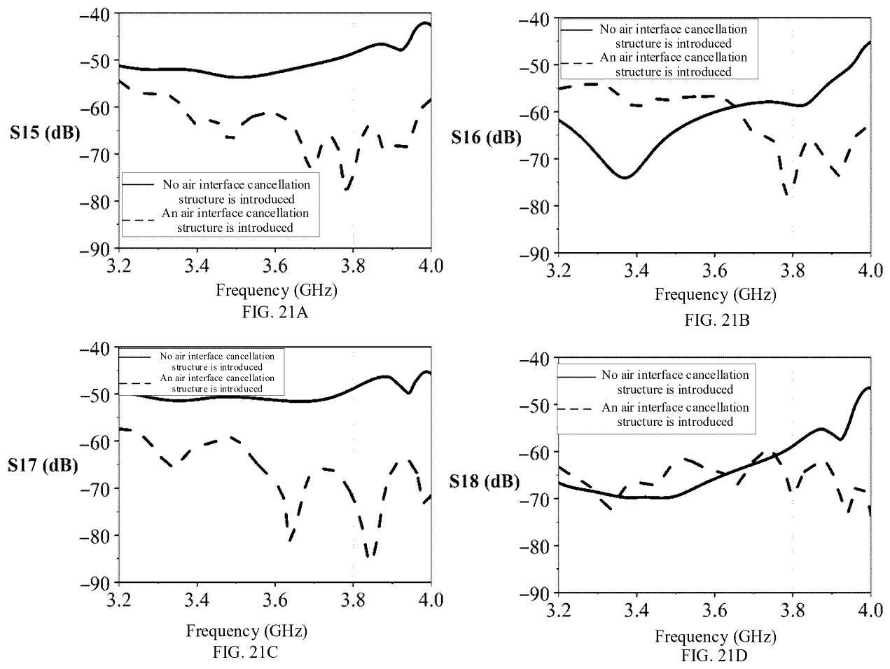

FIGS. 21A-21D shows curves of comparison between scattering parameters (S parameters) of antenna arrays of air interface cancellation structures corresponding to the foregoing four different types of coupling ports and S parameters of antenna arrays into which no air interface cancellation structure is introduced. FIGS. 21A-21D correspond to the foregoing four different types of coupling ports respectively. It can be seen from FIGS. 21A-21D that, after the air interface cancellation structure is introduced, matching of the antenna array is still met. The two types of coupling: S15 and S17, are effectively reduced. S16 and S18 are hardly reduced. Therefore, for a dual-polarized antenna, introduction of the air interface cancellation structure can reduce two types of coupling: H-plane co-polarization coupling of same columns and H-plane co-polarization coupling of adjacent columns in the entire frequency band from 3.3 GHz to 3.8 GHz. Hetero-polarization coupling of same columns and hetero-polarization coupling of adjacent columns are hardly reduced.

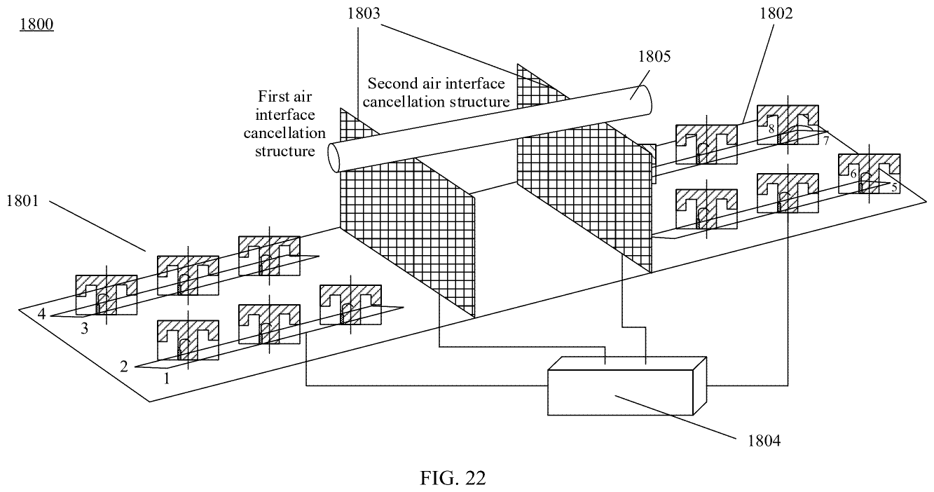

To simulate impact of an interference path in an example environment, in FIG. 22, a metal column 1805 is placed above the antenna array based on FIG. 18. The metal column 1805 causes a change in coupling between radio frequency ports of the first antenna array 1801 and the second antenna array 1802.

It should be noted that introduction of the metal column 1805 does not greatly affect a coupling path between antennas. In the frequency band from 3.3 GHz to 3.8 GHz, the reflection coefficient of each port of the antenna array is still less than −14 dB. However, introduction of the metal column 1805 affects coupling of the antenna. Because the metal column 1805 is placed obliquely above the antenna array, even for a same type of coupling, deterioration degrees of the type of coupling are different. It is learned through simulation that, for co-polarization coupling of same columns, a value of S48 is the worst, for hetero-polarization coupling of same columns, S25 deteriorates most severely, for H-plane co-polarization coupling of adjacent columns, S17 deteriorates most severely, and for hetero-polarization coupling of adjacent columns, S18 deteriorates severely.

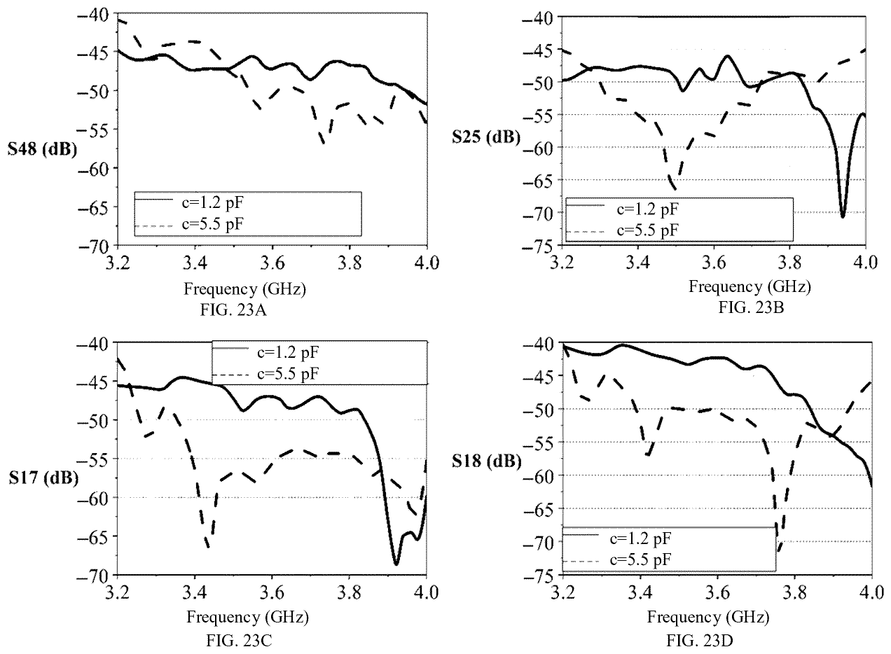

After a capacitance value of the resonance element is adjusted, for example, the capacitance value is increased from 1.2 pF to 5.5 pF, coupling deteriorated due to introduction of the metal column 1805 can be reduced again, and a reduction result is shown in FIGS. 23A-23D. FIGS. 23A-23D correspond to the foregoing four different types of coupling ports respectively. It can be seen that, for co-polarization coupling of same columns, S48 is increased in a frequency band from 3.4 GHz to 3.5 GHz, and S48 can be reduced in a frequency band from 3.5 GHz to 3.8 GHz; for hetero-polarization coupling of same columns, S25 can be effectively reduced in a frequency band from 3.4 GHz to 3.7 GHz; for H-plane co-polarization coupling of adjacent columns, S17 is reduced by 6 dB to 21 dB in the entire frequency band from 3.4 GHz to 3.8 GHz; and for hetero-polarization coupling of adjacent columns, S18 is reduced by 7 dB to 25 dB in the entire frequency band from 3.4 GHz to 3.8 GHz.

Therefore, it can be learned from FIGS. 23A-23D that, when facing impact of a complex environment, the air interface cancellation structure provided in embodiments of this disclosure can reduce capabilities of different types of coupling between the antenna arrays by adjusting capacitance values of the resonance elements.

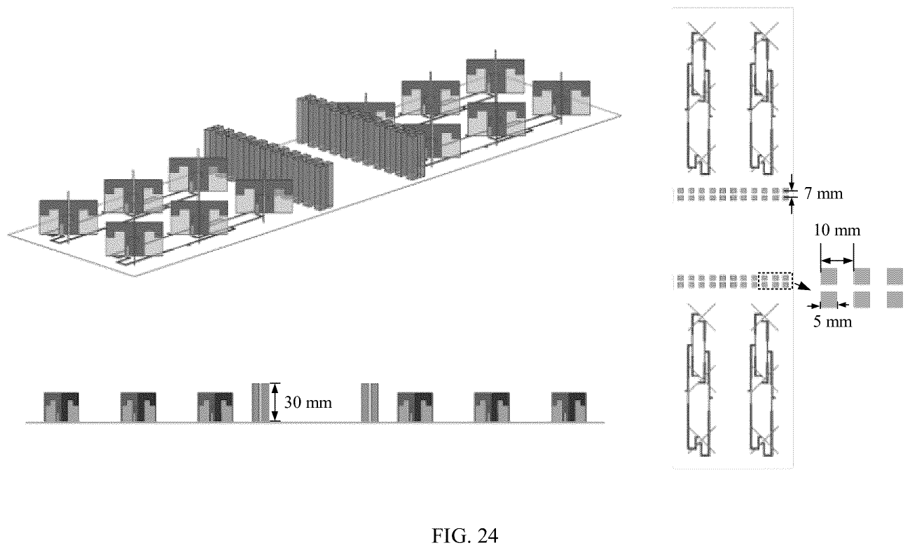

It can be learned from the foregoing analysis of the interference path that, an amplitude of an interference signal introduced by the interference path is far greater than an amplitude of an adjusted signal. Therefore, to implement equal-amplitude and inverse-phase cancellation of the interference signal and the adjusted signal, the amplitude of the adjusted signal may need to be increased. As shown in FIG. 24, two square dielectric columns with a dielectric constant of 30 may be introduced within a range from the first antenna array 2401 to an isolation region. Similarly, two square dielectric columns with a dielectric constant of 30 are introduced within a range from the second antenna array 2402 to the isolation region. A length and a width of each dielectric column are 5 mm, a height of each dielectric column is 30 mm, and a spacing between the two dielectric columns is 7 mm.

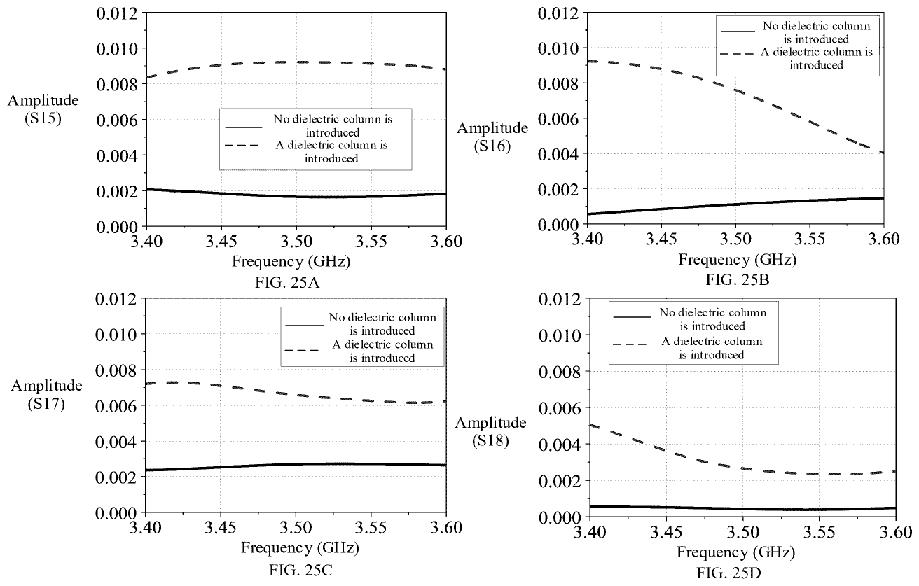

FIGS. 25A-25D are diagrams of a comparison between various coupling amplitudes in an antenna array before a dielectric column is introduced and various coupling amplitudes in the antenna array after the dielectric column is introduced according to an embodiment of this disclosure. It can be seen that, introduction of the dielectric column can increase amplitudes of four different types of coupling in an entire frequency band. For such coupling as S15 (in FIG. 25A), the amplitude is increased from 0.002 to about 0.009, for such coupling as S16 (in FIG. 25B), the amplitude is increased from 0.001 to about 0.007, for such coupling as S17 (in FIG. 25C), the amplitude is increased from 0.002 to about 0.007, and for such coupling as S18 (in FIG. 25D), the amplitude is increased from 0.0005 to about 0.003.

An antenna system and a service scenario that are described in embodiments of this disclosure are intended to describe the technical solutions in embodiments of this disclosure more clearly, and do not constitute a limitation on the technical solutions provided in embodiments of this disclosure. A person of ordinary skill in the art may know that with evolution of the network architecture and emergence of a new service scenario, the technical solutions provided in embodiments of this disclosure are also applicable to a similar technical problem.

Reference to “an embodiment”, “some embodiments”, or the like described in this specification indicates that one or more embodiments of this disclosure include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “contain”, “have”, and their variants all mean “include but are not limited to”, unless otherwise specifically emphasized in another manner.

In this disclosure, “at least one” means one or more, and “a plurality of” means two or more. The term “and/or” describes an association relationship between associated objects, and represents that three relationships may exist. For example, A and/or B may represent the following cases: Only A exists, both A and B exist, and only B exists, where A and B may be singular or plural.

It should be understood that sequence numbers of the foregoing processes do not mean execution sequences in various embodiments of this disclosure. The execution sequences of the processes should be determined based on functions and internal logic of the processes, and should not be construed as any limitation on the implementation processes of embodiments of this disclosure.

It may be clearly understood by a person skilled in the art that, for ease and brevity of description, for a detailed working process of the foregoing system, apparatus, and unit, refer to a corresponding process in the foregoing method embodiment. Details are not described herein again.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. An antenna system comprising:
a first antenna array comprising a first radio frequency port set and configured to transmit a communication signal, wherein the communication signal comprises a first part, a second part, and first signal information;
a second antenna array comprising a second radio frequency port set;
N air interface cancellation structures located between the first antenna array and the second antenna array, sequentially arranged from the first antenna array to the second antenna array, wherein N is an integer greater than or equal to 1, and configured to perform a phase adjustment or both the phase adjustment and an amplitude adjustment on the first part to generate an adjusted signal; and
a feedback circuit connected to the first antenna array, the second antenna array, and the N air interface cancellation structures,
wherein the second antenna array is configured to receive a hybrid signal, wherein the hybrid signal comprises the adjusted signal, an interference signal, and second signal information, and wherein the interference signal is based on the second part, and
wherein the feedback circuit is configured to:
obtain the first signal information and the second signal information; and
adjust an isolation between the first radio frequency port set and the second radio frequency port set based on the first signal information and the second signal information.

2. The antenna system of claim 1, wherein the feedback circuit comprises:
a first input end configured to obtain the first signal information via a first power device and a first circuit switching element; and
a second input end configured to obtain the second signal information via a second circuit switching element.

3. The antenna system of claim 1, wherein each air interface cancellation structure of the N air interface cancellation structures comprises one layer or a plurality of layers.

4. The antenna system of claim 3, wherein each air interface cancellation structure comprises the plurality of layers, wherein each layer comprises a phase adjustment layer or both an amplitude adjustment layer and the phase adjustment layer, wherein the amplitude adjustment layer is configured to adjust an amplitude of the communication signal, and wherein the phase adjustment layer is configured to adjust a phase of a signal occurring after amplitude adjustment.

5. The antenna system of claim 1, wherein each air interface cancellation structure of the N air interface cancellation structures comprises a plurality of resonance elements, and wherein the plurality of resonance elements comprises at least one resonance element for the phase adjustment.

6. The antenna system of claim 3, wherein each layer comprises a plurality of resonance elements, and wherein each resonance element comprises:
a positive electrode;
a negative electrode; and
at least one switch or at least one varactor diode.

7. The antenna system of claim 3, wherein at least one layer of each air interface cancellation structure comprises:
k switches; or
k varactor diodes,
wherein k satisfies k>max(j,m), wherein j is a first quantity of first radio frequency ports in the first radio frequency port set, wherein m is a second quantity of second radio frequency ports in the second radio frequency port set, and wherein both j and m are integers greater than or equal to 1.

8. The antenna system of claim 5, wherein a long side of each resonance element is less than 0.5 times a wavelength of the communication signal.

9. The antenna system of claim 8, wherein the long sides are 0.2 to 0.3 times the wavelength.

10. The antenna system of claim 1, wherein a cross section of each air interface cancellation structure is a right-angle L-shaped structure or an arc L-shaped structure.

11. The antenna system of claim 1, wherein a line length of a cross section of each air interface cancellation structure is 0.2 to 0.6 times a wavelength of the communication signal.

12. The antenna system of claim 1, wherein a first width of each air interface cancellation structure is greater than or equal to a larger value of a second width of the first antenna array and a third width of the second antenna array.

13. The antenna system of claim 1, wherein a spacing between the first antenna array and the second antenna array is greater than a wavelength of the communication signal.

14. The antenna system of claim 13, wherein the spacing is 1 to 1.5 times the wavelength.

15. The antenna system of claim 1, wherein a spacing between an air interface cancellation structure of the N air interface cancellation structures and an edge of the first antenna array is 0.25 times a wavelength of the communication signal.

16. A method comprising:
obtaining first signal information of a communication signal, wherein the communication signal comprises a first part, a second part, and the first signal information;
obtaining second signal information of a hybrid signal, wherein the hybrid signal comprises an adjusted signal, the second signal information, and an interference signal, wherein the adjusted signal is based on a phase adjustment or both the phase adjustment and an amplitude adjustment on the first part, and wherein the interference signal is based on the second part; and
adjusting an isolation between a first radio frequency port set of a first antenna array and a second radio frequency port set of a second antenna array based on the first signal information and the second signal information.

17. The method of claim 16, further comprising:
adjusting an amplitude of the communication signal; and
adjusting a phase of a signal occurring after adjusting the amplitude.

18. An air interface cancellation structure comprising:
resonance elements comprising at least one resonance element for phase adjustment,
wherein each resonance element comprises:
a positive electrode;
a negative electrode; and
at least one switch or at least one varactor diode,
wherein the air interface cancellation structure is configured to be located between a first antenna array and a second antenna array, and perform a phase adjustment or both the phase adjustment and an amplitude adjustment on a part of a communication signal to generate an adjusted signal.

19. The air interface cancellation structure of claim 18, further comprising one layer or a plurality of layers.

20. The air interface cancellation structure of claim 19, further comprising the plurality of layers, wherein the plurality of layers comprise a phase adjustment layer or both an amplitude adjustment layer and a phase adjustment layer, wherein the amplitude adjustment layer is configured to adjust an amplitude of the communication signal, and wherein the phase adjustment layer is configured to adjust a phase of a signal occurring after the amplitude adjustment.
